(19) United States
(12) Patent Application Publication
(10) Pub. No.: US 2009/0004419 A1
(43) Pub. Date: Jan. 1, 2009

(54) MULTI-LAYER MASKING FILM

(76) Inventors: Ronald S. Cok, Rochester, NY (US); Christopher B. Rider, Hardwick (GB)

Correspondence Address: David Novais;Patent Legal Staff, Eastman Kodak Company, 343 State Street, Rochester, NY, 14650-2201, US

(21) Appl. No.: 11/771,133

(22) Filed: Jun. 29, 2007

(51) Int. Cl. B32B 33/00; B29C 65/16

(52) U.S. Cl. 428/40.1; 156/272.8; 428/411.1

(57) ABSTRACT

A multi-layer, disposable, and patternable masking film, comprising:
a) a flexible carrier layer at least partially transparent to a pre-determined frequency of light;
b) a first adhesive layer having adhesion states that change in response to the application of the pre-determined frequency of light and that is coated on the flexible carrier layer; and
c) a first masking layer located next to the first adhesive layer on the side of the first adhesive layer opposite the flexible carrier layer.

### FIELD OF THE INVENTION

The present invention relates to light-emitting devices, and more particularly, to a device and method for depositing light-emitting materials in a pattern over a substrate.

### BACKGROUND OF THE INVENTION

Light-emitting diodes (LEDs) are a promising technology for flat-panel displays and area illumination lamps. The technology relies upon thin-film layers of organic or inorganic materials coated upon a substrate. Organic materials, for example, those found in OLED devices generally can have two formats known as small molecule devices such as disclosed in U.S. Pat. No. 4,476,292, issued Oct. 9, 1984, by Ham et al., and polymer OLED devices such as disclosed in U.S. Pat. No. 5,247,190, issued Sep. 21, 1993, by Friend et al. Inorganic light emitting materials are also known, for example, as found in quantum dots and taught in US 2007/0057263, published Mar. 15, 2007, by Kahen. Either type of LED device may include, in sequence, an anode, an electroluminescent element (EL), and a cathode. The EL element disposed between the anode and the cathode commonly includes a hole-transporting layer (HTL), an emissive layer (EML) and an electron-transporting layer (ETL). Holes and electrons recombine and emit light in the EL layer. Tang et al. (Applied Physics Letter, 51, 913 (1987), Journal of Applied Physics, 65, 3610 (1989), and U.S. Pat. No. 4,769,292, issued Sep. 6, 1988) demonstrated highly efficient OLEDs using such a layer structure. Since then, numerous OLEDs with alternative layer structures, including polymeric materials, have been disclosed and device performance has been improved, as have inorganic light emitting devices.

Light is generated in an LED device when electrons and holes that are injected from the cathode and anode, respectively, flow through the electron transport layer and the hole transport layer and recombine in the emissive layer. Many factors determine the efficiency of this light generating process. For example, the selection of anode and cathode materials can determine how efficiently the electrons and holes are injected into the device; the selection of ETL and HTL can determine how efficiently the electrons and holes are transported in the device, and the selection of EML can determine how efficiently the electrons and holes are recombined and result in the emission of light.

A typical LED device uses a glass substrate, a transparent conducting anode such as indium-tin-oxide (ITO), a stack of organic or inorganic layers, and a reflective cathode layer. Light generated from such a device can be emitted through the glass substrate. This is commonly referred to as a bottom-emitting device. Alternatively, a device can include a non-transparent substrate, a reflective anode, a stack of organic or inorganic layers, and a top transparent electrode layer. Light generated from such an alternative device can be emitted through the top transparent electrode. This is commonly referred to as a top-emitting device.

LED devices can employ a variety of light-emitting organic or inorganic materials patterned over a substrate that emit light of a variety of different frequencies, for example, red, green, and blue, to create a full-color display. For small-molecule organic materials, such patterned deposition is done by evaporating materials and is quite difficult, requiring, for example, expensive metal shadow-masks. Each mask is unique to each pattern and device design. These masks are difficult to fabricate and must be cleaned and replaced frequently. Material deposited on the mask in prior manufacturing cycles may flake off and cause particulate contamination. Moreover, aligning shadow-masks with a substrate is problematic and often damages the materials already deposited on the substrate. Further, the masks are subject to thermal expansion during the OLED material deposition process, reducing the deposition precision and limiting the resolution and size at which the pattern may be formed. Polymer or inorganic LED materials may be deposited in liquid form and patterned using expensive photolithographic techniques.

Alternatively, skilled practitioners employ a combination of emitters, or an unpatterned broad-band emitter, to emit white light together with patterned color filters, for example, red, green, and blue, to create a full-color display. The color filters may be located on the substrate, for a bottom-emitter, or on the cover, for a top-emitter. For example, U.S. Pat. No. 6,392,340, entitled “Color Display Apparatus Having Electroluminescence Elements” and issued May 21, 2002, by Yoneda et al., illustrates such a device. However, such designs are relatively inefficient since approximately two-thirds of the light emitted may be absorbed by the color filters.

The use of polymer, rather than metal, masks for patterning is known in the prior art. For example, WO2006/111766, published Oct. 26, 2006, by Speakman et al., describes a method of manufacturing comprising applying a mask to a substrate; forming a pattern in the mask; processing the substrate according to the pattern; and mechanically removing the mask from the substrate. A method of manufacturing an integrated circuit is also disclosed. However, this method creates significant particulate contamination that can deleteriously affect subsequent processing steps, for example the deposition of materials or encapsulation of a device. Moreover, subsequent location of a mask over a previously patterned area may damage materials in the previously patterned area.

Patterning a flexible substrate within a roll-to-roll manufacturing environment is also known and described in US2006/0283539, published Dec. 21, 2006, by Slafer et al. However, such a method is not readily employed with multiple patterned substrates employing evaporated deposition. Disposable masks are also disclosed in U.S. Pat. No. 5,522,963, issued Jun. 4, 1996, by Anders, Jr. et al., and a process of laminating a mask to a ceramic substrate described. However, the process of registering a mask to the substrate is limited in registration and size. A self-aligned process is described in U.S. Pat. No. 6,703,298, issued Mar. 9, 2004, by Roizin et al., for making memory cells. A sputtered disposable mask is patterned and removed by etching. However, as with the prior-art disclosures cited above, the formation of the mask and its patterning with multiple masking, deposition, and processing steps, are not compatible with delicate, especially organic, materials such as are found in OLED displays.

There is a need, therefore, for an improved mask and method for patterning light-emissive materials that improves resolution and efficiency, reduces damage to underlying layers, reduces particulate contamination, and reduces manufacturing costs.

### SUMMARY OF THE INVENTION

In accordance with one embodiment that addresses the aforementioned need, the present invention provides a multi-layer, disposable, and patternable masking film, comprising:

a) a flexible carrier layer at least partially transparent to a pre-determined frequency of light;

b) a first adhesive layer having adhesion states that change in response to the application of the pre-determined frequency of light and that is coated on the flexible carrier layer; and

c) a first masking layer located next to the first adhesive layer on the side of the first adhesive layer opposite the flexible carrier layer.

### ADVANTAGES

The patterning device and method of the present invention has the advantage that it improves resolution and efficiency, reduces damage to underlying organic layers, reduces particulate contamination, and reduces manufacturing costs for a patterned light-emitting device.

### BRIEF DESCRIPTION OF THE DRAWINGS

FIG. 1 is a partial cross section of a multi-layer mask film according to one embodiment of the present invention;

FIG. 2 is a three-dimensional view of a mask film roll, mask film, material ablation device, and substrate useful for the present invention;

FIG. 3 is a partial cross section of a multi-layer mask film according to another embodiment of the present invention;

FIG. 4 is a partial cross section of a multi-layer mask film according to an alternative embodiment of the present invention;

FIG. 5 is a partial cross section of a multi-layer mask film according to yet another embodiment of the present invention;

FIG. 6 is a partial cross section of a multi-layer mask film with a substrate according to an embodiment of the present invention;

FIG. 7 is a flow chart illustrating a method of forming a patterned, light-emitting device according to one embodiment of the present invention;

FIG. 8 is a flow chart illustrating a method of forming a patterned, light-emitting device according to an alternative embodiment of the present invention;

FIG. 9 is a three-dimensional view of a mask film, material ablation device, and substrate useful for the present invention;

FIG. 10 is a top view of a prior-art display showing the pixel and sub-pixel layout;

FIGS. 11A-11C are top views of a substrate showing various stages of construction according to an embodiment of the present invention;

FIG. 12 is a three-dimensional view of a substrate, mask film, and linear vapor deposition device useful for the present invention; and

FIG. 13 is a three-dimensional view of a patterned mask film located over a substrate having raised areas useful for the present invention.

It will be understood that the figures are not to scale since the individual components have too great a range of sizes and thicknesses to permit depiction to scale.

### DETAILED DESCRIPTION OF THE INVENTION

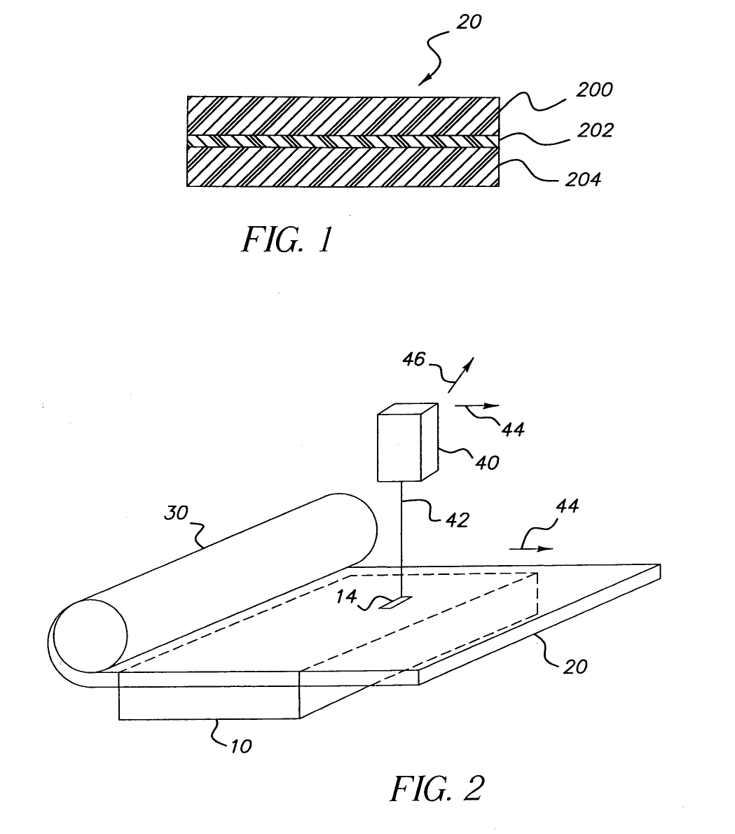

Referring to FIG. 1, in accordance with one embodiment of the present invention, a multi-layer and patternable masking film 20 comprises a flexible carrier layer 200 at least partially transparent to a pre-determined frequency of radiation, a first adhesive layer 202 having adhesion states that change in response to the patterned application of the pre-determined frequency of radiation and that is located on the flexible carrier layer, and a first masking layer 204 located next to the first adhesive layer 202 on the side of the first adhesive layer 202 opposite the flexible carrier layer 200. The adhesive can be coated on the flexible carrier layer or first masking layer by known means in the art, e.g., spin-casting, rolling, spraying, etc. The patternable masking film 20 may be disposable for certain embodiments. According to various embodiments of the present invention the radiation can be micro-wave, infrared, visible light, ultra-violet, or other frequencies of electromagnetic radiation. In at least one embodiment of the present invention the radiation is laser light. In another embodiment an array of infrared heating elements can be employed.

In various embodiments of the present invention, the first adhesive layer 202 may change from a low-adhesion state to a high-adhesion state in response to the application of the pre-determined frequency of light. Alternatively, the first adhesive layer 202 may change from a high-adhesion state to a low-adhesion state in response to the application of the pre-determined frequency of light. As employed herein, a high adhesion state adheres the masking layer to the flexible carrier layer more strongly than does a low adhesion state. Hence, the high adhesion state is tackier than a low adhesion state; for example, as described in U.S. Pat. No. 6,610,762 issued to lain Webster. In various embodiments of the present invention the adhesive layer of the multi-layer film may be in a high adhesion state and exposed to patterned radiation to form a pattern of low adhesion areas in the multi-layer film. In other embodiments of the present invention the adhesive layer of the multi-layer film may be in a low adhesion state and exposed to patterned radiation to form a pattern of high adhesion areas in the multi-layer film. Hence, a positive or negative patterned exposure may be employed together with adhesives that are switched from a low to a high adhesion state or vice versa.

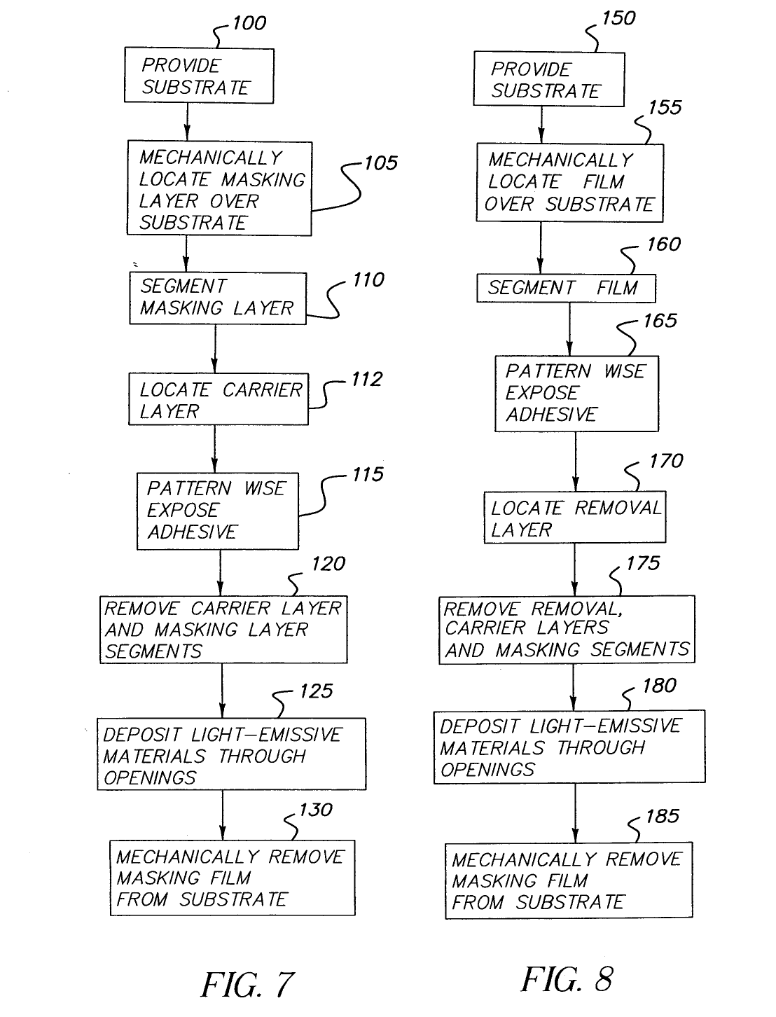

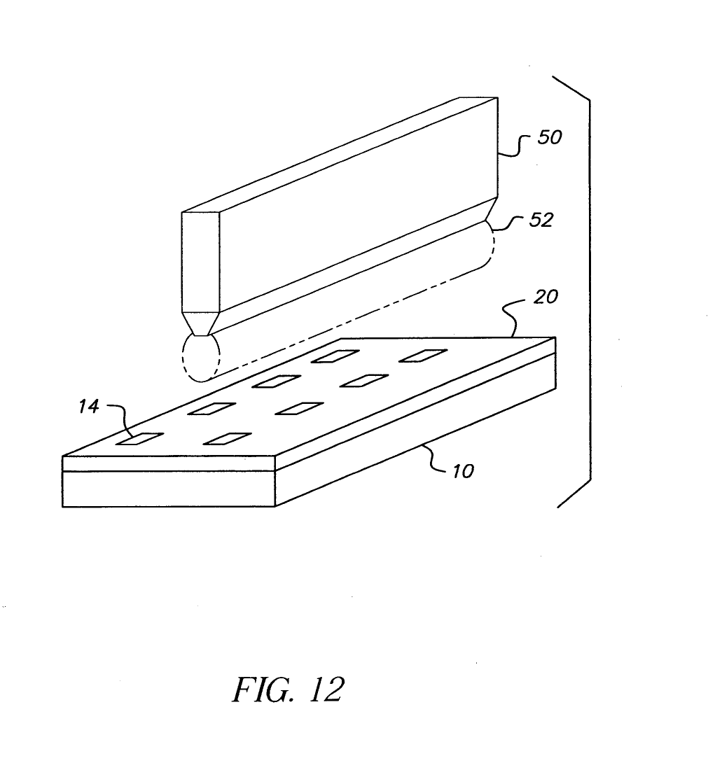

Referring to FIG. 7, in an embodiment of a method of the present invention, a multi-layer, disposable, and patternable masking film is formed over a substrate in step 100 by providing a substrate 105; locating a masking layer having a first adhesive layer having adhesion states that change in response to the application of a pre-determined frequency of radiation coated on a side of the masking layer opposite the substrate 110; segmenting the masking layer into portions 112; locating a flexible opposite carrier layer over the first adhesive layer, the flexible carrier layer being at least partially transparent to the pre-determined frequency of light, and 115; patternwise exposing desired portions of the first adhesive layer according to the portioned masking layer with the pre-determined frequency of radiation to adhere the corresponding portions of the masking layer 204 to the carrier layer 200. In further embodiments of the method of the present invention, the carrier layer and segmented and adhered portions of the masking layer 204 and adhesive are removed 120 (for example, using mechanical means) to form mask openings in the multi-layer masking film 20 that expose corresponding portions of the substrate or underlying layers and protectively mask the remaining portions of the substrate or underlying layers. Light-emissive materials may be deposited 125 (e.g. by a plume of evaporated materials 52 from a linear source 50 as shown in FIG. 12) through the mask openings to form a patterned deposition of materials. The multi-layer masking film may then be removed 130 from the substrate. The process may be repeated multiple times.

Referring to FIG. 2, the masking layer may be patterned by employing a laser 40 that emits laser light 42 and ablates the material in the periphery of the mask hole openings 14 in multi-layer mask film 20 located over substrate 10. The laser light (or laser) is moved in orthogonal directions 44 and 46 to scan the periphery of the mask hole 14 and thereby segment mask hole 14 from the remainder of the mask film 20. Alternatively, the substrate may be moved in one direction while the laser beam 42 scans in the orthogonal direction, thereby enabling a continuous process. Other means for patterning the masking film 20 may be employed, for example, waterjet, mechanical cutting means, or acoustic means (e.g., ultrasound), as are known in the art. The masking film 20 may be dispensed from a roll 30 of masking film material and located over the substrate 10. Likewise, when the masking film 20 is removed, the material may be picked up on a second roller (not shown) as additional masking film material is advanced from the roller 30. Rolls of films, mechanisms for moving and locating the films over a substrate, lasers, and mechanisms for scanning lasers over a surface are all known in the art. FIG. 9 illustrates a more detailed view including the laser 40, laser light 42, the masking film 20 over the substrate 10, and a mask hole 14 with a periphery 14b and interior 14a.

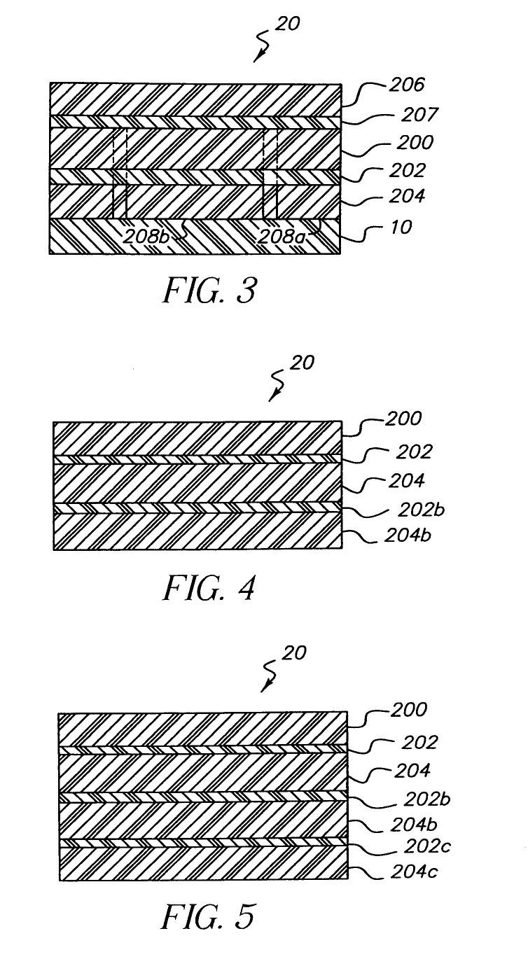

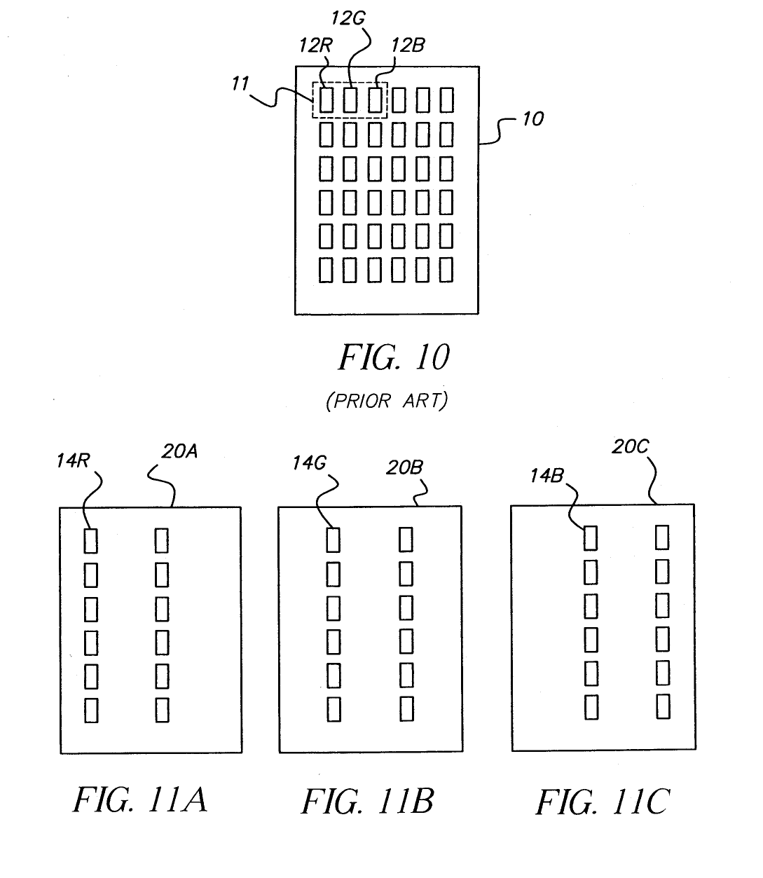

FIG. 3 illustrates a partial cross section of the masking film 20 located over a substrate 10. The masking film 20 has a flexible carrier layer 200, a first adhesive layer 202, having adhesion states that change in response to the application of the pre-determined frequency of light, and that is coated on the flexible carrier layer 200, and a first masking layer 204 located next to the first adhesive layer 202 on the side of the first adhesive layer 202 opposite the flexible carrier layer 200 and opposite the substrate 10. Masking layer 204 is segmented into portions 208a and 208b. The portions 208a and 208b of the masking layer 204 may be contiguous to aid removal, for example, by forming the portions into stripes as illustrated in FIG. 10 with columns of red, green, and blue emitters.

While the masking layer 204 absorbs a pre-determined frequency of light to segment the masking layer 204, the flexible carrier layer 200 is at least partially transparent to the pre-determined frequency of light so that at least some of the light passes through the flexible carrier layer 200. Alternatively, the flexible carrier layer 200 may also absorb the pre-determined frequency of light and be segmented as shown in FIG. 3 with the dashed lines. In this case, a removal layer 206 may be located over the carrier layer 200 after the carrier layer 200 is segmented. An adhesive layer 207 may then serve to assist in adhering the carrier layer 200 to the removal layer 206 to remove the masking film 20. It is helpful if the adhesive layer 207 has a higher adhesion than the adhesive layer 202 in its low-adhesion state, so that the removal layer 206 can effectively pull the carrier layer 200 (and adhered mask layer portions 208b) from the substrate 10 particularly if, as shown in FIG. 6, the multi-layer masking film 20 is adhered to the substrate 10 with an adhesive layer 202d.

Referring to FIG. 8, the removal layer may be employed in an embodiment of a method according to the present invention by step 150 providing a substrate; 155 locating a masking film having a first adhesive layer having adhesion states that change in response to the application of a pre-determined frequency of light coated on a side of the masking layer over a substrate; 160 segmenting the masking film into portions; 165 patternwise exposing the adhesive to change the adhesion state of selected portions corresponding to the segmented portions of the mask layer; 170 locating a removal layer over the flexible carrier layer; and 175 removing the removal and carrier layers and those segmented portions of the masking layer that are adhered to the carrier layer. Light-emissive materials may be deposited in operation 180 (e.g. by a plume of evaporated materials 52 from a linear source 50 as shown in FIG. 12) through the mask openings to form a patterned deposition of materials. The multi-layer masking film may then be removed in operation 185 from the substrate. The process may be repeated multiple times.

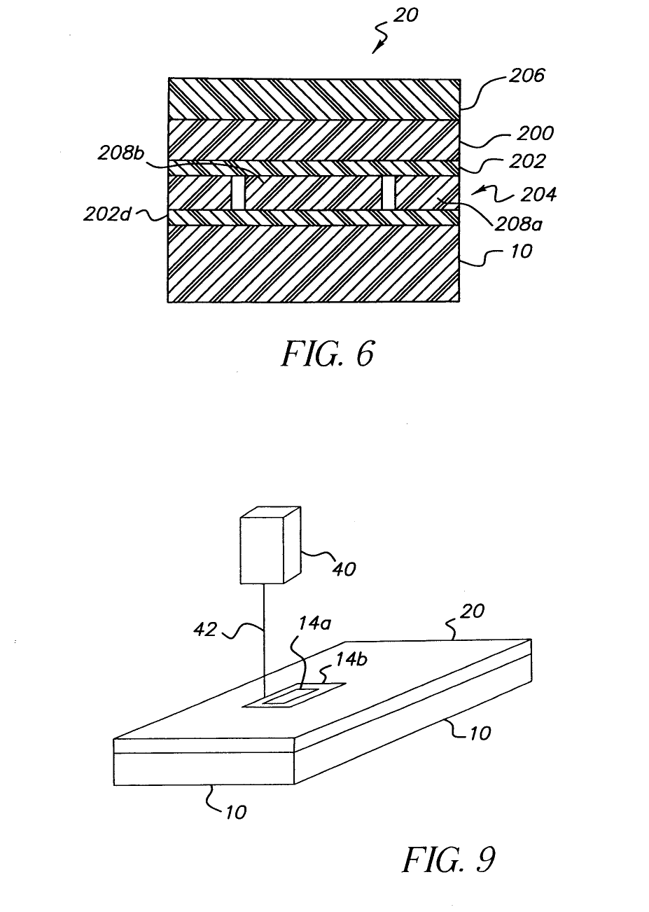

Referring to FIGS. 4, 5, and 6 in other embodiments of the present invention, the multi-layer masking film 20 may comprise a second masking layer 204b and a second adhesive layer 202b located between the first masking layer 204 and the second masking layer 204b. As shown in FIG. 5, a third masking layer 204c and third adhesive layer 202c may be located over the second masking layer 204b. These multiple layers assist in further patterning the substrate, as is taught in commonly-assigned, co-pending U.S. application Ser. No. 11/692,381 which is hereby incorporated by reference in its entirety.

While the masking film 20 itself need not be registered with the light-emitting areas 12 on the substrate 10, the mask hole openings 14 may correspond with the light-emitting areas 12 and also be registered with them. Such registration may be aided by providing, for example, fiducial marks on the substrate. Such marks and the mechanisms for scanning lasers and ablating material to a necessary tolerance are known in the art, as are devices for collecting ablated material. Typical mask hole openings are, for example, 40 microns by 100 microns in size.

In an alternative embodiment of the present invention, the masking film 20 includes light-absorptive areas adapted to selectively absorb laser light so that ablation only occurs in the light-absorptive areas. Light-absorptive areas, in the peripheral locations of the mask hole openings 14, can be formed by printing light-absorbing materials on the masking film, for example by inkjet or gravure processes, before or after the masking film 20 is located over the substrate 10. The light-absorptive areas correspond to the periphery 14b of the masking holes 14. In this way, the entire masking film 20 (or portions thereof) is exposed at one time to ablate material in the light-absorptive areas, thereby increasing the amount of material that may be ablated in a time period and decreasing the amount of time necessary to form the mask hole openings 14 in the masking film 20.

In most embodiments of the present invention, the openings in the masking film may be formed in different locations so that different light-emissive materials may be deposited in the different locations over the substrate 10. Moreover, more than one light-emissive material is deposited through the openings, as may other materials, and the materials can be formed in layers over the same location on the substrate 10 as the light-emissive materials. For example, the light-emissive materials may comprise a plurality of light-emitting layers. The light-emissive materials can be organic materials comprising a small-molecule or polymer molecule light-emitting diodes. Alternatively, the light-emissive materials can be inorganic and comprise, for example, quantum dots.

Referring to FIG. 10, in a prior-art design, pixels 11 comprise three patterned light-emitting elements or sub-pixels 12R, 12G, 12B, each patterned light-emitting element emitting light of a different color, for example red, green, and blue, to form a full-color display. In other designs, four-color pixels are employed, for example, including a fourth white, yellow, or cyan light-emitting element. As shown in FIG. 10, the light-emitting elements 12R, 12G, 12B are arranged in a stripe configuration such that each color of light-emitting element forms a column of light-emitting elements emitting the same color of light. In other designs, the light-emitting elements are arranged in delta patterns in which common colors are offset from each other from one row to the next row. Alternatively, four-element pixels may be arranged in two-by-two groups of four light-emitting elements. All of these different designs and layouts are included in the present invention.

As taught in the prior art, for example, in manufacturing OLED devices, deposition masks may be made of metal and are reused multiple times for depositing evaporated organic materials. The masks are cleaned but are, in any event, expensive, subject to thermal expansion, difficult to align, and problematic to clean. In particular, the present invention does not employ photolithographic methods of liquid coating, drying, patterned exposure forming cured and uncured areas, followed by a liquid chemical removal of the cured or uncured areas to form a pattern. In contrast, the present invention provides a very low-cost, single-use mask that is patterned while in place over the substrate, thereby overcoming the limitations of the prior art. The mask may be formed of flexible thin films of, for example, polymers, either transparent or non-transparent and is patterned in a completely dry environment, that is, no liquid chemicals are employed.

Referring to FIGS. 11A, 11B, and 11C, in one embodiment of the method of the present invention, three mask films are successively employed. Each mask has openings in different locations that are referred to as “mask holes”. Through out this application “mask holes” and “openings” in the mask are used interchangeably. Three different types of material are deposited through mask holes 14R, 14G, 14B in three different sets of locations corresponding to the light-emitting element locations 12R, 12G, and 12B in the layout of FIG. 3. In this embodiment, a first multi-layer masking film 20A is firstly located over the substrate and the material in the patterned mask holes 14R in the multi-layer masking film 20A is removed. Light-emitting material is then deposited through the mask holes 14R onto the corresponding substrate light-emitting element locations 12R; the first multi-layer masking film 20A is subsequently removed. In a second series of steps, a second multi-layer masking film 20B is secondly located over the substrate and the material in the patterned mask holes 14G in the multi-layer masking film 20B is removed. Light-emitting material is then deposited through the openings 14G onto the corresponding substrate light-emitting element locations 12G and the second multi-layer masking film 20B subsequently removed. The pattern in the first and second films may be different to expose different light-emitting areas. In a third series of steps, a third multi-layer masking film 20C is thirdly located over the substrate and the material in the mask holes 14B in the multi-layer masking film 20C is removed. Light-emitting material is then deposited through the mask holes 14B in yet another different pattern onto the corresponding substrate light-emitting element locations 12B and the third multi-layer masking film 20C are subsequently removed. At this stage, three different materials are patterned in three different sets of light-emitting element locations 12R, 12G, and 12B over the substrate to form a plurality of full-color light-emitting pixels. Any remaining processing steps necessary to form a complete device may then be performed. For example, an OLED device using patterned OLED materials may be employed in either a top- or bottom-emitter configuration. Note that the present invention can be combined with the unpatterned deposition of other layers to form a complete light-emitting device. Such unpatterned materials may include charge-injection layers, and charge-transport layers as are known in the organic and inorganic LED arts. Moreover, the areas of the mask holes 14 may be larger than the light-emitting areas 12. Since the light-emitting area 12 is typically defined by patterned device electrodes (not shown), it is only necessary to deposit material over the electrode areas corresponding to light-emitting elements 12. Additional material may be deposited elsewhere to ensure that deposition tolerances are maintained.

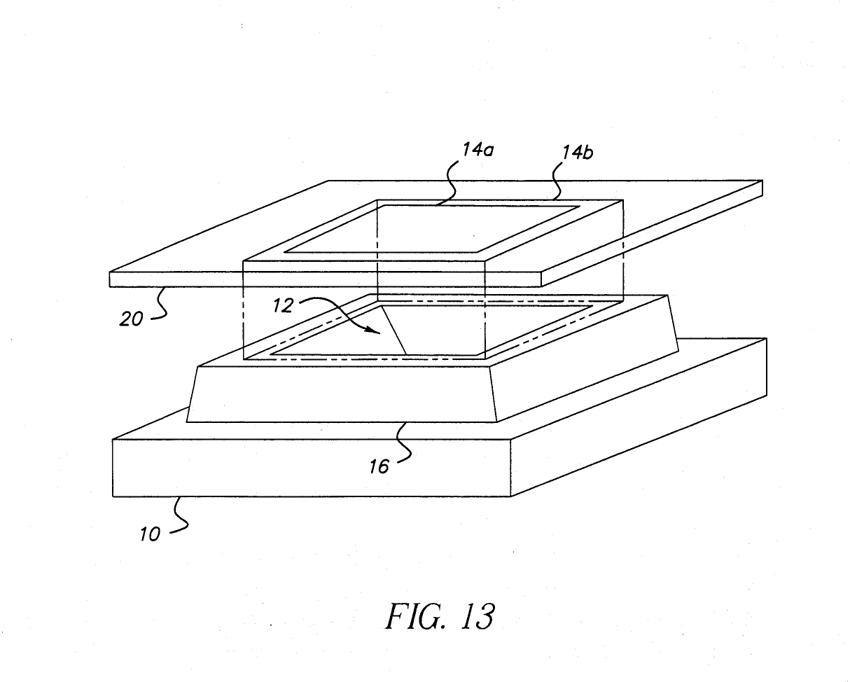

Referring to FIG. 13, in another embodiment of the present invention, raised areas 16 are formed over the substrate 10. Such raised areas can comprise, for example, photolithographic materials such as photo-resist or silicon dioxides or silicon nitrides formed on the substrate through photolithographic processes and may be, for example, 20 microns to 50 microns wide, depending on the tolerances of the processes used to pattern the substrate electrodes or thin-film electronic components. The raised areas 16 may be located around a light-emitting area 12 and may be employed to insulate electrodes formed over the substrate 10. Such processes are well known in the photolithographic art and have been employed in, for example, OLED devices. The masking film 20 may be located over the substrate 10 and in contact with the raised areas 16. The masking film 20 may be adhered to the raised areas 16 of the substrate 10. Laser ablation may be performed to remove the material in the perimeter 14b of the mask hole 14. The remaining masking film material 14a is adhered to the carrier layer and then detached. By employing a raised area 16, the multi-layer masking film 20 is prevented from contacting the substrate 16 and any pre-existing layers located in the light-emitting areas 12.

As shown in FIG. 13, the mask hole perimeter 14b is located over the raised areas 16 (as shown by the dashed lines). In this embodiment, the laser light 42 is not directed into the light-emitting element area 12, thereby avoiding any problems that might result from exposing existing layers of material that may be already present in the light-emitting areas 12 (for example, inadvertent ablation of pre-deposited organic materials). Note that the area of the mask hole 14 may be larger than the light-emitting area 12. The illustrations of FIG. 13 show the substrate 10 below the masking film 20; however, the positions of the substrate 10 and masking film 20 may be reversed.

In summary, the method of the present invention can be employed to form, for example, a patterned, light-emitting device, comprising a substrate, light-emitting areas located over the substrate, and light-emitting materials pattern-wise deposited in the light-emitting areas through a masking film mechanically located over the substrate, the masking film having patterned openings formed, while the masking film is located over the substrate and mechanically removed after the light-emitting materials are deposited. Hence, according to various embodiments of the present invention, a patterned, light-emitting device can be formed by first patterning the substrate with electrodes, active-matrix components, and the like, as is known in the display art. One or more unpatterned layers may also be deposited over the substrate. These steps can be performed in a vacuum. Subsequently, the substrate may be located in a masking chamber having an atmosphere, for example, a nitrogen atmosphere. The first masking film is located over the substrate, the surface is used to adhere the masking film over the substrate, the mask holes are formed for a first pattern of light-emitting elements that emit a common color of light by detaching material from the masking film in locations corresponding to the first pattern, and the pressure chamber employed to remove the detached material and dispose of the detached material. The substrate may be detached from a masking film dispensing mechanism and removed from the masking chamber to a vacuum chamber and light-emitting materials deposited through the mask holes, for example, by employing a linear source to deposit organic LED materials. The substrate is then returned to a masking chamber and the masking film removed. A second masking film is similarly provided and adhered and a second pattern of mask holes is formed. If the second pattern of mask holes is relatively aligned with the first pattern, the same surface having the same holes, but aligned to the second pattern, may be employed to remove the detached material. Since the patterns are typically highly structured and similar in pattern, the same surface and hole structure may be employed. The substrate is then removed, coated with different light-emitting materials in a vacuum through the second pattern of mask holes, returned to the masking chamber, and the second mask film removed. The third process proceeds likewise, resulting in a three-color light-emitting device. Any final un-patterned layers, for example, an unpatterned electrode, may be applied and the device encapsulated.

The present invention provides many improvements over the prior art. The masking film may be inexpensive, for example comprising PEN or PET or other low-cost polymers provided in rolls. The film does not have to be repeatedly aligned with the substrate, as do traditional metal masks, nor do temperature dependencies arise, since the materials do not necessarily expand significantly in response to temperature; and if significant thermal expansion were to occur, the heat would only slightly decrease the area of the masking holes. If the masking holes are slightly oversized (as would be the case if a perimeter was ablated over a raised area), no effect on the formation of the light-emitting element would result. Because the film covers all of the substrate, except those areas to be patterned with light-emitting materials, the substrate is protected from particulate contamination. Moreover, because a new film is provided for each deposition cycle, particulate contamination formed by removing masking film material may be removed when the masking film is mechanically removed. Employing a raised area around the light-emitting areas likewise prevents damage to any pre-existing light-emitting areas, as does ablating a perimeter over the raised areas around mask holes. In any case, the masking film may be sufficiently thin that touching any delicate layers of, for example, organic materials, on the substrate may not damage the layers.

The present invention also provides a scalable means for manufacturing patterned light-emitting devices, since the masking film can be readily made in large sizes. Laser systems useful for ablating masking film materials may comprise many separate lasers, therefore enabling fast patterning. Such laser systems are known in the art. The use of a patterned plate to remove the detached material enables fast turnaround on arbitrarily large substrates. The patterned plate itself may be employed many times, without cleaning, reducing costs. Hence, the present invention can be employed in continuous processing systems, since the time-consuming steps (such as the mask hole formation) may be done in a continuous process while the provision and removal of the masking film requires relatively little time.

Laser ablation techniques, film, adhesives, controllable adhesives, and mechanical attachment and mechanical detachment techniques are all known in the art, as are light-emitting materials (organic, polymer, or inorganic) and other layers such as charge-control layers, electrodes, and thin-film electronic devices suitable for the control of flat-panel display or illumination devices.

Examples of controllable adhesives are thermosetting adhesives that are not tacky at ambient temperature, but which become tacky as they are heated with infrared radiation; hot-melt adhesives that may be activated by infrared radiation; and ultra-violet or visible light curing adhesives. A specific example of a suitable adhesive film would be the B-staged adhesive films from TechFilm® that can be switched (or changed) from one adhesion state to another by radiation from an IR laser.

OLED devices of this invention can employ various well-known optical effects in order to enhance their properties if desired. This includes optimizing layer thicknesses to yield maximum light transmission, providing dielectric mirror structures, replacing reflective electrodes with light-absorbing electrodes, providing anti-glare or anti-reflection coatings over the display, providing a polarizing medium over the display, or providing colored, neutral density, or color conversion filters over the display. Filters, polarizers, and anti-glare or anti-reflection coatings may be specifically provided over the cover or as part of the cover.

The present invention may also be practiced with either active- or passive-matrix OLED devices. It may also be employed in display devices or in area illumination devices. In a preferred embodiment, the present invention is employed in a flat-panel OLED device composed of small molecule or polymeric OLEDs as disclosed in, but not limited to, U.S. Pat. No. 4,769,292, issued Sep. 6, 1988 to Tang et al., and U.S. Pat. No. 5,061,569, issued Oct. 29, 1991 to VanSlyke et al. Many combinations and variations of organic light-emitting displays can be used to fabricate such a device, including both active- and passive-matrix OLED displays having either a top- or bottom-emitter architecture. The present invention can be employed to manufacture any patterned light-emitting device, regardless of design, layout, or number of light-emitting elements or colors of light-emitting elements and specifically includes displays having red, green, and blue sub-pixels and displays having red, green, blue, and white sub-pixels.

The invention has been described in detail with particular reference to certain preferred embodiments thereof, but it will be understood that variations and modifications can be effected within the spirit and scope of the invention.

### PARTS LIST

10 substrate
11 pixel
12 light-emitting element
12R red light-emitting element
12G green light-emitting element
12B blue light-emitting element
14 mask hole
14R opening in masking film for red light-emitter
14G opening in masking film for green light-emitter
14B opening in masking film for blue light-emitter
14a mask hole material within perimeter of mask hole
14b mask hole perimeter
16 raised area
20, 20A, 20B, 20C masking film
30 roll of masking film
40 laser
42 laser light
44, 46 direction
50 linear source
52 plume of evaporated particles
100 provide substrate step
105 locate masking film step
110 form openings step
112 segment into portions step
115 deposit light-emitting materials step
120 remove masking film step
125 locate masking film step
130 form openings step
150 provide substrate step
155 locate masking film step
160 segment film step
165 patternwise expose adhesive step
170 locate removal layer step
175 remove masking step
180 deposit light emitting materials step
185 form openings step
200 carrier layer
202, 202b, 202c, 202d adhesive layer
204, 204b, 204c mask layer
206 removal layer
207 adhesive layer
208a, 208b masking layer portions

1. A multi-layer and patternable masking film, comprising:
a) a flexible carrier layer at least partially transparent to a pre-determined frequency of light;
b) a first adhesive layer having adhesion states that change in response to the patterned application of radiation and that is located on the flexible carrier layer; and
c) a first masking layer located next to the first adhesive layer on the side of the first adhesive layer opposite the flexible carrier layer.

2. The multi-layer film of claim 1, wherein the first adhesive layer is changeable from a low-adhesion state to a high-adhesion state in response to the patterned application of radiation.

3. The multi-layer film of claim 1, wherein the masking layer absorbs a pre-determined frequency of radiation after it passes through the flexible carrier layer.

4. The multi-layer film of claim 1, further comprising a removal layer located over the carrier layer and a second adhesive layer formed between the removal layer and the carrier layer.

5. The multi-layer film of claim 1, further comprising a second masking layer and a second adhesive layer located over the first masking layer.

6. The multi-layer film of claim 5, further comprising a third masking layer and third adhesive layer located over the first masking layer.

7. The multi-layer film of claim 1, wherein the first masking layer is segmented into separate portions.

8. The multi-layer film of claim 7, wherein the flexible carrier layer is segmented into separate portions.

9. The multi-layer film of claim 1, wherein the first masking layer is segmented into separate portions and the flexible carrier layer is not segmented into portions.

10. The multi-layer film of claim 1, wherein either the flexible carrier layer or the first masking layer, or both, are segmented into two separated, but contiguous portions.

11. The multi-layer film of claim 1, wherein the multi-layer film is located over a substrate or segmented on a substrate.

12. The multi-layer film of claim 2, wherein the patterned application of radiation is laser light.

13. The multi-layer film of claim 11, wherein either the first masking layer or the flexible carrier layer comprises polymeric materials.

14. The multilayer film of claim 1, further comprising a fourth adhesive layer located on a side of the first masking layer, opposite the first adhesive layer and wherein the fourth adhesive layer has a lower adhesion than the first adhesive layer in at least one of its adhesive states.

15. A method of forming a multi-layer and patternable masking film over a substrate, comprising the steps of:
a) locating a masking layer having a first adhesive layer having adhesion states that change in response to the application of a pre-determined frequency of radiation coated on a side of the masking layer over a substrate, the first adhesive layer located on the side of the masking layer opposite the substrate;
b) segmenting the masking layer into portions;
c) locating a flexible carrier layer over the first adhesive layer, the flexible carrier layer being at least partially transparent to the pre-determined frequency of radiation; and
d) patternwise exposing desired portions of the first adhesive layer according to the portioned masking layer with the pre-determined frequency of radiation.

16. The method of claim 15, further comprising the step of removing the flexible carrier film and desired portions of the masking layer and the first adhesive layer from the substrate.

17. The method of claim 15, wherein segmenting of the masking layer is accomplished through laser ablation.

18. The method of claim 15, wherein the patternwise exposure of the first adhesive layer with the pre-determined frequency of radiation changes the adhesion state of the adhesive layer from a low adhesion state to a high adhesion state.

19. The method of claim 15, further comprising the step of locating a removal layer over the flexible carrier layer, the removal layer having a second adhesive layer located between the removal layer and the flexible carrier layer and whose adhesion is stronger than the adhesion of the first adhesive layer.

20. The method of claim 15, further comprising the step of removing the masking layer from the substrate.
